(19) United States
(12) Patent Application Publication
(10) Pub. No.: US 2007/0024017 A1
(43) Pub. Date: Feb. 1, 2007

(54) Locking mechanism for movable subframe of tractor-trailers

(75) Inventor: John Edward Ramsey, Canton, OH (US)

Correspondence Address: DAVID P DURESKA;BUCKINGHAM DOOLITTLE & BURROUGHS, LLP, 4518 FULTON DRIVE, NW, P O BOX 35548, CANTON, OH, 44735-5548, US

(73) Assignee: Hendrickson USA, L.L.C.

(21) Appl. No.: 11/494,342

(22) Filed: Jul. 27, 2006

Related U.S. Application Data
(60) Provisional application No. 60/703,910, filed on Jul. 29, 2005.

(51) Int. Cl. B62D 53/06

(52) U.S. Cl. 280/149.2

(57) ABSTRACT

An improved locking mechanism for a movable subframe of a tractor-trailer has a pair of transversely-spaced main members extending longitudinally beneath a body of the tractor-trailer, at least one cross member extending between and being attached to the main members, and an axle/suspension system attached to and depending from the main members. At least one clamping mechanism is attached to the subframe and mechanically engages a longitudinally extending rail of the body of the tractor-trailer to enable efficient selective positioning of the subframe relative to the body. Undesirable movements between the subframe and the tractor-trailer body are minimized by fore-aft and/or vertical clamping loads exerted on the body rail and the subframe by the clamping mechanism. This secure positioning allows portions of the trailer body and/or subframe to be constructed of lightweight materials which in turn permits the tractor-trailer to carry larger payloads.

### CROSS-REFERENCE TO RELATED APPLICATION

This application claims the benefit of U.S. Provisional Patent Application Ser. No. 60/703,910, filed on Jul. 29, 2005.

### BACKGROUND OF THE INVENTION

1. Technical Field

The invention relates to tractor-trailer subframes and, in particular, to movable subframes for tractor-trailers. More particularly, the invention is directed to a movable subframe for tractor-trailers which includes a clamping arm mechanism for locking the movable subframe into a selected position relative to the tractor-trailer body, wherein the movable subframe is effectively clamped to the trailer body rails so that gyrations of the subframe are reduced or minimized after the subframe is locked into position and during operation of the vehicle, thereby enabling the use of weight-saving aluminum trailer body rails and cross sills and enhancing the advantages of an aluminum slider box.

2. Background Art

Specifically, movable subframes, typically referred to as slider boxes, slider subframes, slider undercarriages, or slider secondary frames, have been utilized on tractor-trailers or semi-trailers for many years. One or more axle/suspension systems usually are suspended from a single slider box. For purposes of clarity, hereinafter the movable subframe incorporating the improved locking mechanism of the present invention will be referred to as a slider box. It is understood that a slider box outfitted with usually two axle/suspension systems typically is referred to as a slider or slider tandem, and again, for purposes of clarity will hereinafter be referred to as a slider tandem. The slider tandem in turn is mounted on the underside of the trailer primary frame or floor structure, and is movable longitudinally therealong to provide a means for variable load distribution and vehicular maneuverability. Specifically, the slider tandem can be used on flatbeds having a primary frame, van trailers having a floor structure, and the like.

More specifically, the amount of cargo that a trailer may carry is governed by local, state and/or national road and bridge laws, and is dependent on proper load distribution. The basic principle behind most road and bridge laws is to limit the maximum load that a vehicle may carry, as well as limit the maximum load that can be supported by individual axles. A trailer having a slider tandem gains an advantage with respect to laws governing maximum axle loads. More particularly, proper placement of the slider tandem varies individual axle loads or redistributes the trailer load so that it is within legal limits.

Conventional or prior art slider box designs were developed before the advent of air suspension systems for trailers. At that time, leaf spring suspension systems were the suspension of choice for van trailers with slider boxes. However, the leaf spring suspension system was unable to provide adequate load equalization between the axles of the slider tandem and therefore was subject to possible overload situations.

Moreover, the subsequent development of air suspension systems provided load equalization among multiple axles for tractor-trailers, with or without the utilization of slider boxes, as well as improved ride quality for individual axles. Of course, the combination of a movable slider box and an air suspension system provided maximum versatility with respect to variable load distribution and load equalization in a trailer and increased maneuverability. Unfortunately, prior art slider boxes equipped with air suspensions add unwanted weight to the trailer, primarily because those slider boxes were originally built to support leaf spring suspensions and adapting them to incorporate air suspensions required additional bracing and support.

Additionally, vehicles containing more than one non-steerable axle, including tractor-trailers, are subject to lateral or side loads. Lateral loads can act through the slider box in opposite directions, and the effect of such lateral or bending loads on the slider box can be significant. Moreover, a slider box is subjected to strong vertical and longitudinal or fore-aft loads. Thus, the loads to which the slider box is subjected must be controlled by the slider box design. Prior art slider box designs control vertical loads by utilizing rigid, and therefore heavy, main members and cross members typically made of steel. This increases the weight of the frame, thereby reducing the amount of payload that can be carried by the tractor-trailer as governmental weight limitations remain constant irrespective of the weight of the vehicle.

Thus, within the trucking industry, reducing the weight of carrier equipment without sacrificing durability directly improves productivity by increasing the available payload that can be transported by the vehicle. Slider boxes made of steel have contributed to the excessive weight problems that have plagued slider tandems in the past. Although certain prior art slider boxes formed of steel have exhibited weight and durability improvement over other prior art steel slider boxes, as well as improvements to the structure and operation of prior art retractable pin mechanisms, the trucking industry is continually striving for improvement in slider box design. However, attempts to utilize materials that are lighter than steel to construct slider boxes, such as aluminum, have been largely unsuccessful and inefficient.

Turning now to the manner in which a slider tandem operates, once properly positioned, the slider tandem heretofore typically has been locked into place on the underside of the trailer by a retractable pin mechanism. The retractable pin mechanism of the prior art generally includes two or more, and typically four, retractable pins which may be interconnected by a usually manually operated crank mechanism. When the pins are in their extended or outboardmost position, they each pass through a respective opening formed in the slider box and a selected aligned one of a plurality of openings formed in rails of the trailer body. The pins thereby lock the slider tandem in the selected position relative to the trailer body. However, these pins can become jammed. The mechanical advantage enjoyed by the manual operator of the pin mechanism, which is used for retracting the pins when it becomes necessary to reposition the slider tandem, is designed to overcome spring forces which bias the pins to the locked position. The mechanical advantage is not designed to free or retract jammed pins from their locked position. Since the mechanical advantage is sometimes inadequate, prior art slider tandem pin mechanisms rely on either the brute force of the tractor-trailer operator or add-on devices designed to release jammed pins.

In assessing the causes for jammed pins, it has been discovered that shear forces are imposed on the individual pins. The shear forces operate on the pin perpendicular to the longitudinal axis of each cylindrical pin. More specifically, slight movement of the slider tandem relative to the trailer body during operation of the tractor-trailer can cause slight misalignment between the respective slider box and trailer body openings through which each pin extends or passes when in the locked position. This misalignment can in turn cause contact pressure points between each pin and its respective trailer body rail opening, aligned slider box opening, and the mounting bracket opening located adjacent to the inboard end of the pin. The contact pressure points in turn cause the above-mentioned shear forces on the pins. Such whipsaw-like or jamming forces can become greater than the force that a tractor-trailer operator is able to manually apply through the crank mechanism to free the pins.

Thus, when prior art pins become jammed, the operator of the tractor-trailer risks personal injury due to overexertion in attempting to manually free jammed pins, and further risks damaging the retractable pin mechanism. Specifically, a typical method of attempting to release prior art jammed pins is for the tractor-trailer operator to rock the trailer fore and aft, while an assistant operates the retractable pin mechanism. The rocking motion momentarily realigns the misaligned openings, so that the assistant can retract the pins during the brief period of realignment. The process has been simplified by a prior art quick-release device which allows the vehicle operator to maneuver the trailer while the quick release device automatically frees the jammed pins, thus effectively obviating the need for another person to operate the crank mechanism. However, such quick release devices add expense to the slider box, and such an exercise can be time-consuming and also can create wear on the retractable pin mechanism.

Yet another problem associated with prior art locking pins, which is related to the pin jamming problem, is that the holes formed in the trailer body rails and through which the slider box pins protrude when in the locked position, are approximately 0.25″ oversized to allow the pins to pass through the respective holes after tolerances and deflections are accounted for. This relatively sloppy fit allows the slider box pins to gyrate back and forth and up and down within the holes during trailer operation. Such movements, in turn, can cause each pin to forcibly contact, or bang, the trailer body rail opening at the interface of the slider pin and the trailer body rail. Such movement and pin banging, in turn, causes lateral movement and misalignment of the slider tandem, which can adversely affect tracking, cause excessive tire wear, and exacerbate the jamming of pins. This movement also places additional and undesirable stresses on the slider box and the trailer body rails, and dictates that those components be made of steel, as opposed to a lighter material such as aluminum, to provide acceptable component life. The steel body rails alone add approximately 100 lbs. apiece to the weight of the trailer and further dictate the use of steel cross sills in trailers having a floor structure frame, which enables easy welding of the steel rails to the steel floor structure but also adds additional undesirable weight. As there are approximately 17 cross sills on a typical trailer floor structure in the slider area, substantial weight savings could be achieved through the use of sills made of aluminum, as opposed to steel.

Thus a need exists in the art for an improved locking mechanism for a slider box that overcomes the problems and deficiencies of the prior art, mainly unwanted movement, gyrations and pin jamming, and yet still allows the slider box to be constructed of lightweight materials in order to provide vehicle operators an improved slider box that can carry larger payloads.

### BRIEF SUMMARY OF THE INVENTION

An objective of the present invention is to provide a slider box incorporating an improved locking mechanism that securely fastens a slider tandem to the trailer body rails of a tractor-trailer.

Another objective of the present invention is to provide a slider box incorporating an improved locking mechanism that allows the operator to easily lock and unlock the slider tandem for easy repositioning of the slider tandem with respect to the trailer body rails, while effectively substantially minimizing the stresses associated with the relatively loose fit of prior art locking pin mechanisms.

Yet another objective of the present invention is to provide a slider box incorporating an improved locking mechanism that allows for the use of lighter materials, such as aluminum, in constructing the trailer body rails, cross sills, and other components of the slider box, and which in turn significantly reduces the overall weight of the trailer, thereby improving cargo-carrying efficiency.

A further objective of the present invention is to provide a slider box incorporating an improved locking mechanism that reduces the amount of effort expended by the operator when repositioning the slider tandem, and further permits the operator to easily determine whether the slider box is properly engaged, thereby improving safety for the operator and the traveling public.

These objectives and advantages are obtained by the movable subframe for a tractor-trailer which includes a pair of transversely spaced-apart main members extending longitudinally relative to a longitudinally-extending trailer body of the tractor-trailer, at least one cross member extending between and being attached to the main members, at least one axle/suspension system mounted on and depending from the subframe, and at least one clamping mechanism mounted on the subframe for clampingly engaging the trailer body for selectively positioning the subframe relative to the trailer body.

### BRIEF DESCRIPTION OF THE SEVERAL VIEWS OF THE DRAWINGS

The preferred embodiment of the invention, illustrative of the best mode in which applicant has contemplated applying the principles of the invention, is set forth in the following description and is shown in the drawings, and is particularly and distinctly pointed out and set forth in the appended claims.

FIG. 1 is a driver's-side top-front fragmentary perspective view of a prior art slider box for a tractor-trailer, showing the retractable pin mechanism used to selectively position the slider box along the underside of a trailer body, and further showing depending hangers for suspending axle/suspension systems from the slider box;

FIG. 2 is an enlarged fragmentary driver's-side elevational view of a prior art slider tandem, including the prior art slider box shown in FIG. 1, and showing two axle/suspension systems, with portions broken away and hidden portions represented by broken lines;

FIG. 3 is a reduced-size rear fragmentary elevational view of the prior art slider tandem shown in FIG. 2 movably mounted on the underside of a trailer body, with portions thereof represented by broken lines;

FIG. 4 is a greatly-enlarged fragmentary view taken from the circled area in FIG. 3, showing one of the pins of the retractable pin mechanism in the locked position;

FIG. 5 is a greatly-enlarged fragmentary top view of the retractable pin mechanism of the prior art slider box shown in FIG. 1, with portions thereof in section and hidden portions represented by broken lines, and showing one of the pins of the retractable pin mechanism in an unlocked position and showing the pin opening of the slider box slightly mis-aligned with the pin opening of the trailer body;

FIG. 6 is a view similar to FIG. 5, showing one of the pins of the retractable pin mechanism of the prior art slider box in a locked position and showing contact pressure points imparted on the pin as a result of the ordinary movement of the slider box relative to the trailer body during operation of the vehicle;

FIG. 7A is an enlarged outboard perspective view of the driver's side improved locking mechanism for a slider box of the present invention, showing the clamping arm mechanism including the housing, the arm base, and the clamping arms;

FIG. 7B is a condensed view similar to FIG. 7A with a portion of the arm base and one of the front L-shaped plates removed, showing the front opening in the spacer, and with the outboard housing plate removed and showing the location of the air spring, the coil springs, and the locking mechanism within the housing;

FIG. 8A is a top driver's side perspective view of the improved locking mechanism of the present invention incorporated into a slider tandem, and showing the clamping arm mechanism locking the tandem into a selected position on the rails of a trailer body;

FIG. 8B is an enlarged fragmentary top-front outboard perspective view of the improved locking mechanism for a slider box of the present invention with portions of the trailer body rail removed, showing the manner in which the upper arms of one of the clamping arm mechanisms engages its respective trailer body rail for locking a slider tandem in a selected position beneath the trailer;

FIG. 9 is an outboard elevational view of the improved locking mechanism for a slider box of the present invention, with the outboard housing plate removed and showing the slider box main member and trailer body rail in section, and further showing the clamping arm mechanism in an unlocked position;

FIG. 10 is a view similar to FIG. 9, but showing the clamping arm mechanism in a partially locked position; and

FIG. 11 is a view similar to FIGS. 9 and 10, but showing the clamping arm mechanism in a locked position.

Similar numerals refer to similar parts throughout the drawings.

### DETAILED DESCRIPTION OF THE INVENTION

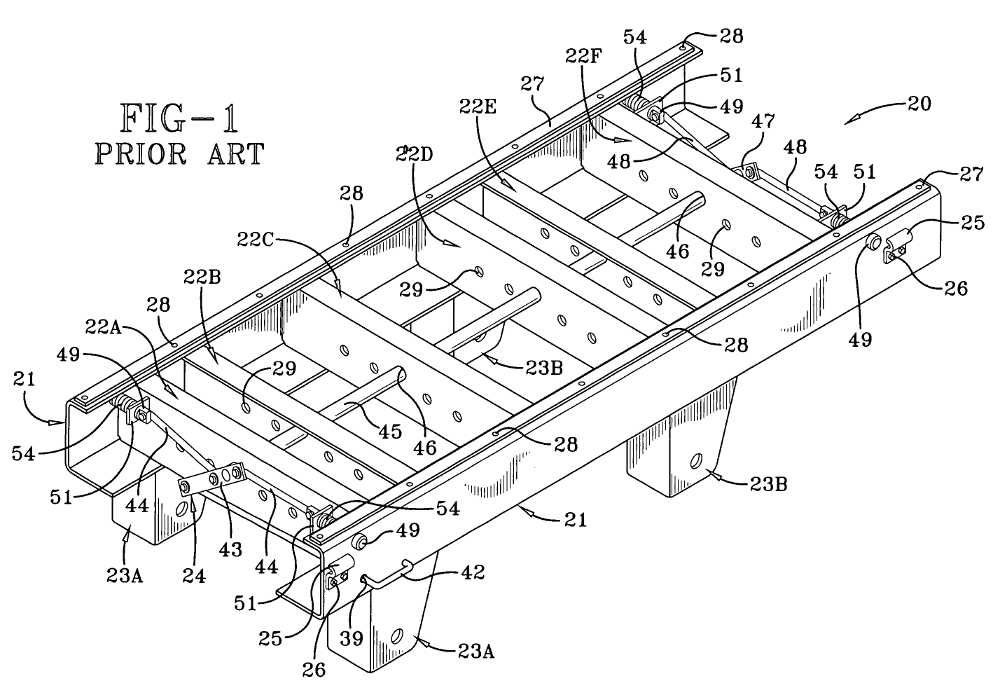

So that the structure, operation and advantages of the improved locking mechanism for a slider box of the present invention can be best understood, a slider box for a tractor-trailer having a prior art retractable locking pin mechanism is indicated generally at 20 and is shown in FIG. 1. Slider box 20 includes a pair of longitudinally extending main members 21, a plurality of cross members 22A through F, and a retractable pin mechanism 24. Front and rear pairs of hangers 23A and 23B, respectively, are attached to and depend from slider box main members 21 for suspending axle/suspension systems.

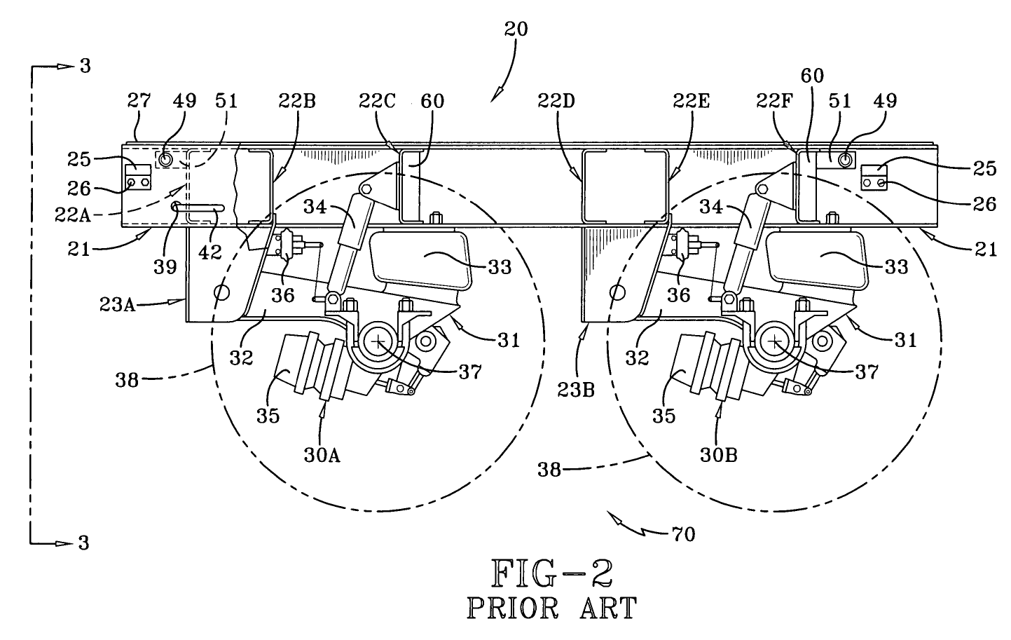

Specifically, and as further shown in FIG. 2, each main member 21 is an elongated, generally C-shaped beam made of a metal such as steel or other suitable material. The open portion of each main member 21 is opposed to the open portion of the other main member and faces inboard relative to slider box 20. Main members 21 are connected to each other in spaced-apart parallel relationship by cross members 22A-F, which extend between in fore-aft spaced-apart parallel relationship and are perpendicular to main members 21. Each end of each cross member 22 nests in the open portion of a respective one of main members 21, and is secured therein by any suitable means such as welding or mechanical fastening. Each cross member 22 is a generally C-shaped beam also made of a metal such as steel or other suitably robust material, and has a plurality of openings 29 formed in its vertically extending surface. Openings 29 are aligned with corresponding openings formed in the other cross members 22 to provide for passage of air and/or fluid conduits, electrical lines, and the like, used in the operation of the tractor-trailer (not shown). Each front hanger 23A is attached by welding or other suitable means, to the lowermost surface of a respective one of main members 21 at a location directly beneath cross members 22A, B. Each rear hanger 23B similarly is attached to main members 21 at a location directly beneath cross members 22D, E.

Each main member 21 has a pair of rail guides 25 mounted on its outboard surface by bolts 26, or other suitable means of attachment, such as welding. Each rail guide 25 is mounted adjacent to a respective one of the ends of main member 21. A low friction strip 27 is attached to the uppermost surface of each main member 21 by recessed fasteners 28, and extends generally the entire length of main member 21. Low friction strip 27 is formed of any suitable low-friction material, such as ultra-high molecular weight polyethylene.

As mentioned hereinabove, and as best shown in FIG. 2, slider box 20 supports front and rear axle/suspension systems 30A and 30B, respectively, wherein the slider box and axle/suspension systems combine to form a slider tandem, which is indicated generally at 70 in FIG. 2. Inasmuch as each axle/suspension system 30A,B is suspended from slider box 20, but does not form an integral part thereof, only the major components of system 30 will be cited for aiding in the description of the environment in which the slider box and prior art retractable pin mechanism 24 operates. Each axle/suspension system 30A,B includes generally identical suspension assemblies 31 suspended from respective pairs of hangers 23A,B. Each suspension assembly 31 includes a suspension beam 32 which is pivotally mounted on hanger 23 in a usual manner. An air spring 33 is suitably mounted on and extends between the upper surface of the rearwardmost end of suspension beam 32 and main member 21 at a location directly beneath a certain one of the cross members 22C,F. A shock absorber 34 extends between and is mounted on suspension beam 32 and the certain cross member 22C,F. One or more reinforcement struts 60 are strategically attached within each cross member 22C,F to strengthen the cross member for supporting suspension assemblies 31. Other components of suspension assembly 31, mentioned herein only for the sake of relative completeness, include an air brake 35 and a height control valve 36. An axle 37 extends between and is captured in the pair of suspension beams 32 of each axle/suspension system 30A,B. Wheels 38 are mounted on each end of axle 37.

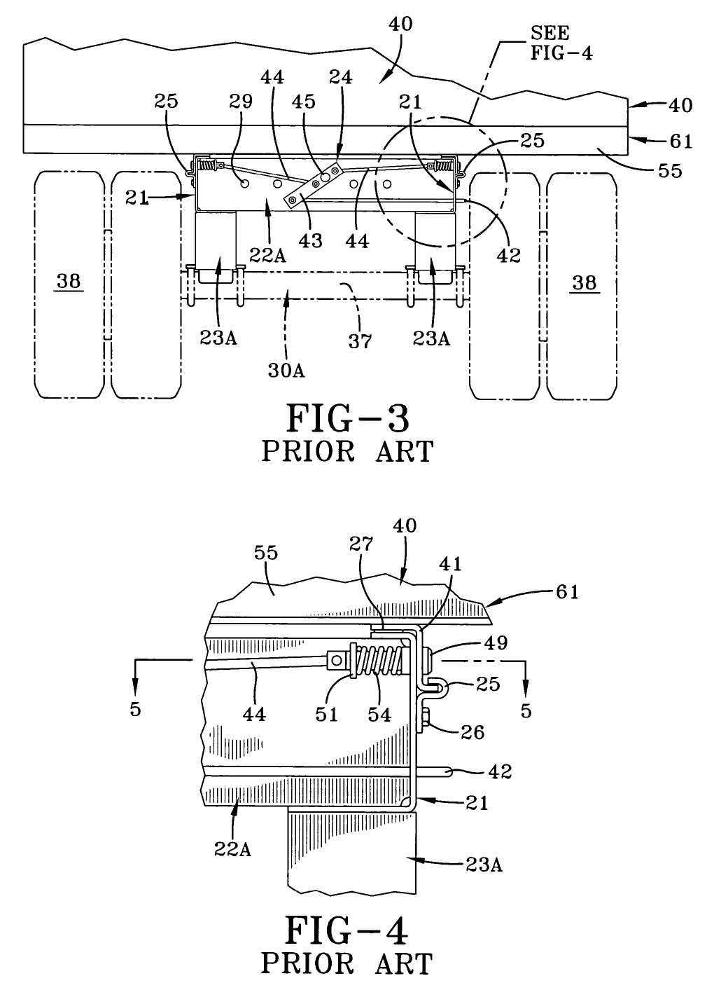

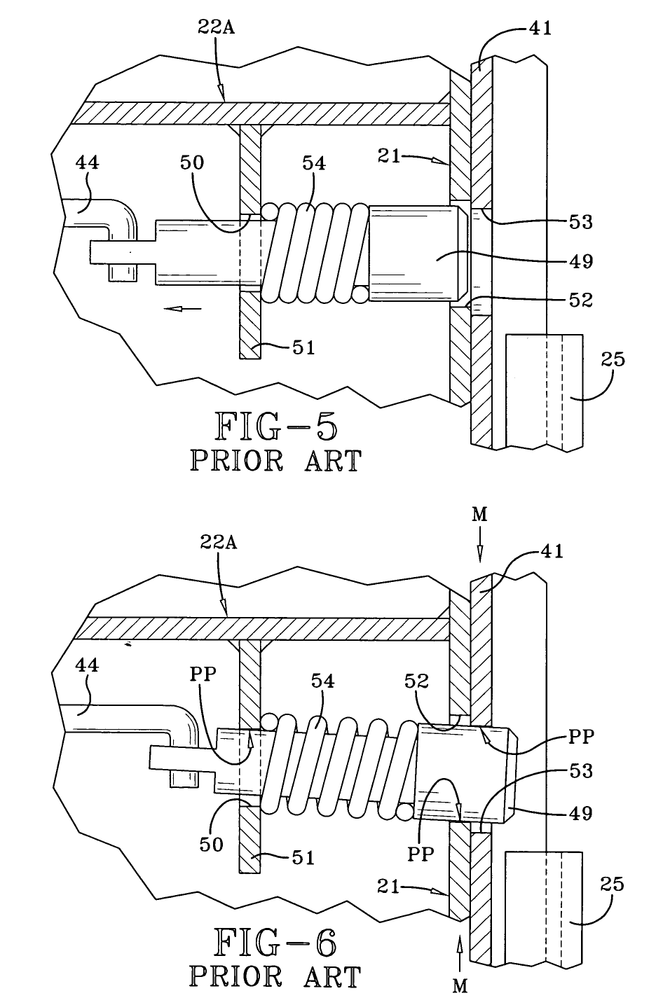

Slider tandem 70 is movably mounted on trailer body 40 (FIGS. 3 and 4) by slidable engagement of rail guides 25 with spaced apart, parallel, and generally Z-shaped rails 41, which are mounted on and depend from the underside of a floor structure 61 of the trailer body. More specifically, each Z-shaped rail 41 preferably is typically formed of a metal such as steel and weighs about 100 pounds. Since steel Z-shaped rails 41 conventionally are welded to floor structure 61 of a trailer body 40, cross sills 55 of the floor structure also conventionally are formed of steel to facilitate welding. Cross sills 55, which support floor structure 61 of the trailer, typically number about 17 within the area directly above Z-shaped rails 41. Each low friction strip 27 abuts the bottom surface of the uppermost portion of a respective one of Z-shaped rails 41 to provide a smooth, generally friction-free contact surface for slidable movement of slider tandem 70 beneath trailer body 40.

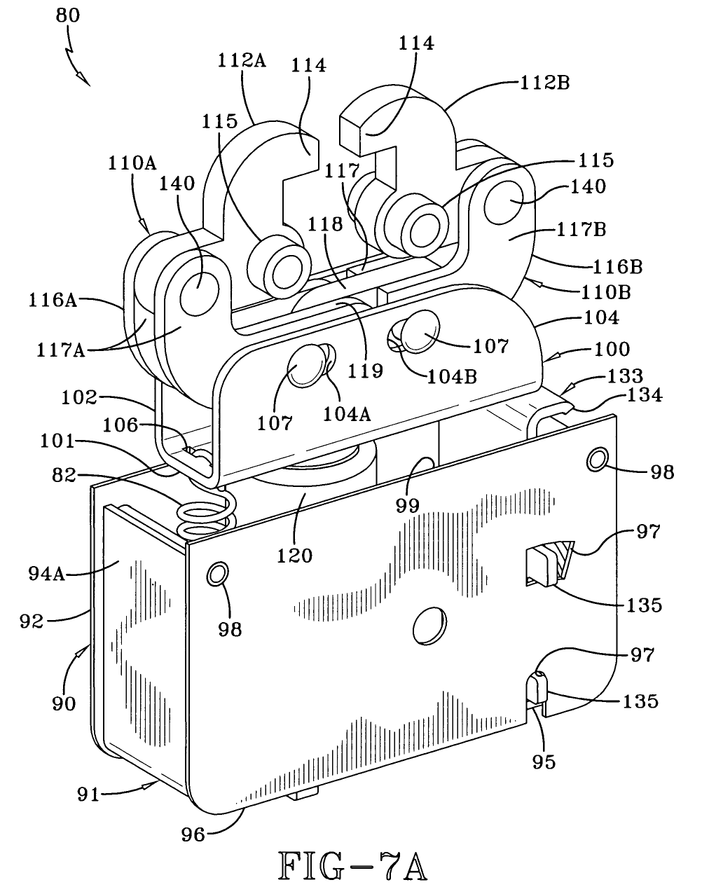

As is well-known in the art, slider tandem 70 can be selectively positioned relative to trailer body 40 for optimum load distribution by retractable pin mechanism 24. As best shown in FIGS. 1, 3 and 4, pin mechanism 24 includes a generally L-shaped handle 42, which passes through an opening 39 formed in a selected one of main members 21, but usually on the driver's side of the tractor-trailer. It can be seen that the bent end portion of handle 42, which extends outwardly from the outboard side of main member 21, is accessible for easy grasping by an operator of the tractor-trailer. The inboard end of handle 42 is pivotally attached to an arm or a lever 43, which in turn is pivotally attached to a pair of arms 44 which extend in opposite outboard directions from lever 43. Lever 43 further is attached to an elongated, longitudinally extending pivot rod 45 which passes rearwardly through a plurality of aligned openings 46 formed in cross members 22. The rear end of pivot rod 45 remote from lever 43 similarly is attached to a remote lever 47, which in turn is pivotally attached to a pair of arms 48 which extend in opposite outboard directions from the remote lever. The outboard end of each one of arms 44, 48 is bent (FIG. 5) and is pivotally attached to the inboard end of a prior art locking pin 49.

The inboard end of each prior art locking pin 49 is slidably mounted (FIG. 5) in an opening 50 formed in a bracket 51 which is attached by suitable means such as welding to a respective one of cross members 22A and 22F. The enlarged cylindrical outboard end of each locking pin 49 passes through a generally round or circular-shaped opening 52 formed in a respective one of main members 21. When it is desired to lock slider tandem 70 in a selected position relative to trailer body 40, the slider box main member openings 52 are aligned with selected ones of a plurality of correspondingly sized openings 53 formed in Z-shaped rails 41 of the trailer body. Each locking pin 49 automatically passes through the selected aligned openings 52,53 since the locking pin is biased in an outboard direction by a coil spring 54 captured between bracket 51 and the enlarged outboard end of locking pin 49. When it is again desired by the operator of the tractor-trailer to move slider tandem 70 beneath trailer body 40, the parking brake of the trailer is engaged, handle 42 is pulled in an outboard direction to retract pins 49 out of trailer rail openings 53 and against the bias of springs 54, and slider 20 is moved longitudinally along Z-shaped rails 41 until slider box main member openings 52 align with selected trailer rail openings 53 and prior art locking pins 49 engage therewith as described hereinabove for maximizing load distribution.

Due in part to the aforementioned problems associated with the use of prior art locking pins, including gyrations of slider tandem 70 due to the relatively sloppy fit of locking pins 49 in aligned openings 52,53 as the vehicle travels over-the-road, the above-described prior art Z-shaped rails 41 and cross sills 55 of floor structure 61 are formed of steel. Forming such components from steel enables trailer body 40 and Z-shaped rails 41 to withstand such gyrations, but using the steel material increases the overall weight of the trailer which is undesirable and inefficient.

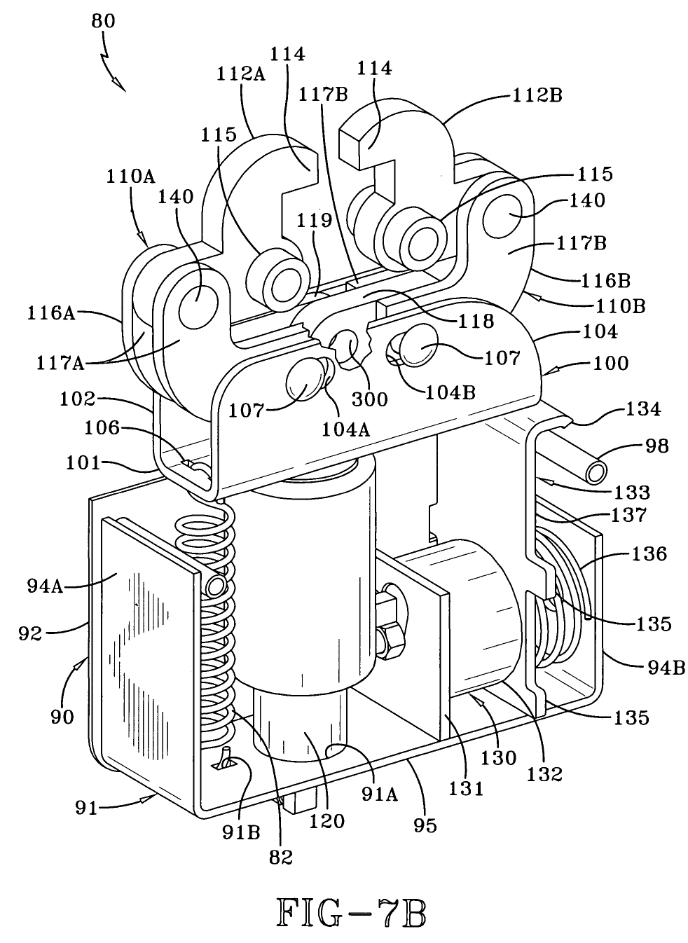

Moreover, as is best shown in FIGS. 4 and 5 and especially FIG. 6, it can be appreciated that prior art locking pins 49 can become jammed during routine operation of retractable pin mechanism 24. More particularly, shear forces are caused to operate on pins 49 when they are in the extended or locked position, because of slight movement of prior art slider box 20 and its main members 21 relative to trailer body 40 and its Z-shaped rails 41, causing misalignment as indicated by arrows M in FIG. 6. Specifically, this movement results in slight misalignment between slider box openings 52 and trailer body rail openings 53. The misalignment in turn causes contact pressure points between each pin 49 and its respective trailer body rail opening 53, slider box main member opening 52, and bracket opening 50, as represented by arrows PP. The contact point pressure in turn causes the shear forces which operate on the pin perpendicular to the longitudinal axis of each pin to resist retraction of the pins to the unlocked position.

The mechanical advantage enjoyed by the manual operator of retractable pin mechanism 24 must be greater than the combined shear forces acting on jammed pins 49 in order to retract or free the pins to the unlocked position shown in FIG. 5. However, the mechanical advantage often is inadequate, and so the operator must personally exert additional physical force to free the jammed pins. This type of overexertion by the operator can cause personal injury and/or damage to retractable pin mechanism 24. Specifically, a typical method of attempting to release prior art jammed pins is for the operator to rock trailer body 40 fore and aft, while an assistant operates the retractable pin mechanism. The rocking motion briefly realigns misaligned openings 52,53 so that the assistant can retract the pins during the period of realignment. Also, add-on devices designed to release jammed pins, such as a prior art quick-release device which allows the operator to maneuver the trailer while the quick-release device automatically frees the jammed pins, eliminates the need for another person to operate the retractable pin mechanism. While the quick-release device does make freeing jammed pins a one-person job, it still requires the operator to rock the trailer which is time consuming, can cause damage to the retractable pin mechanism, and adds weight and additional installation and maintenance expense.

The improved locking mechanism for a slider box of the present invention eliminates the undesirable stresses and jamming associated with prior art retractable pin mechanism 24 by replacing the mechanism with the clamping arm locking mechanism of the present invention, thereby permitting the use of lighter materials, such as aluminum, to construct the trailer body rails and cross sills and enhancing the advantages of an aluminum slider box.

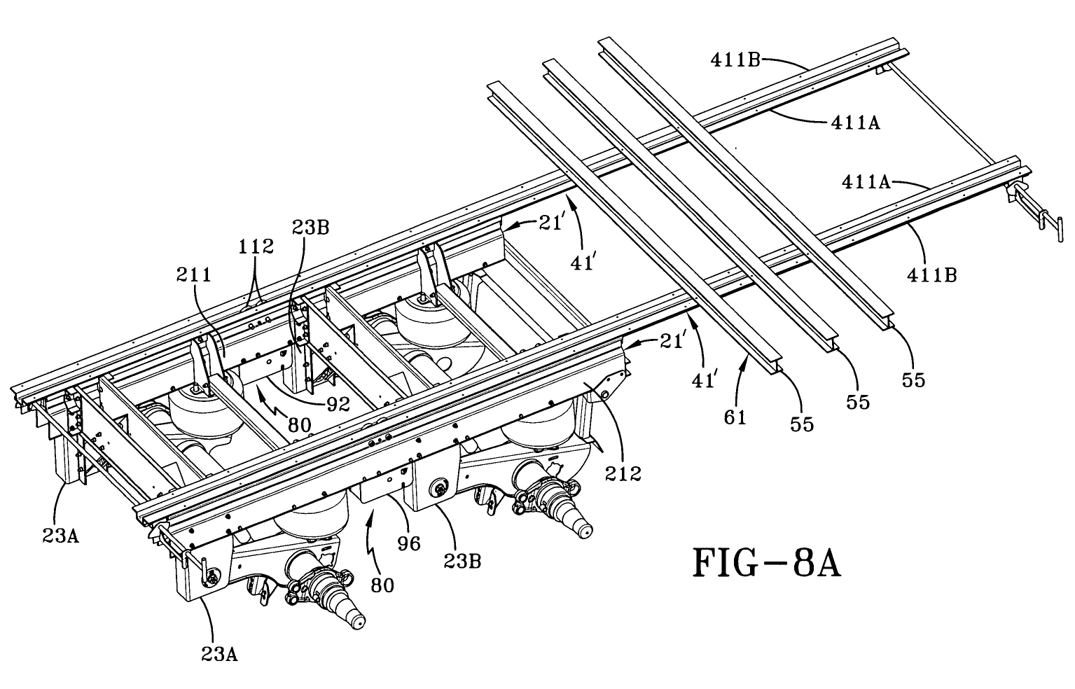

The improved locking mechanism for a slider box of a tractor-trailer of the present invention is indicated generally at 80 and is shown in FIGS. 7 through 11. The environment in which locking mechanism 80 of the present invention operates is generally identical to that described above for prior art retractable pin mechanism 24, with any differences in structure and operation between the environment adapted for use with the present invention and that of the prior art being particularly described below. Inasmuch as a pair of clamping arm mechanisms 80 are utilized on a slider box, but are generally identical in structure and operation, only one will be described herein.

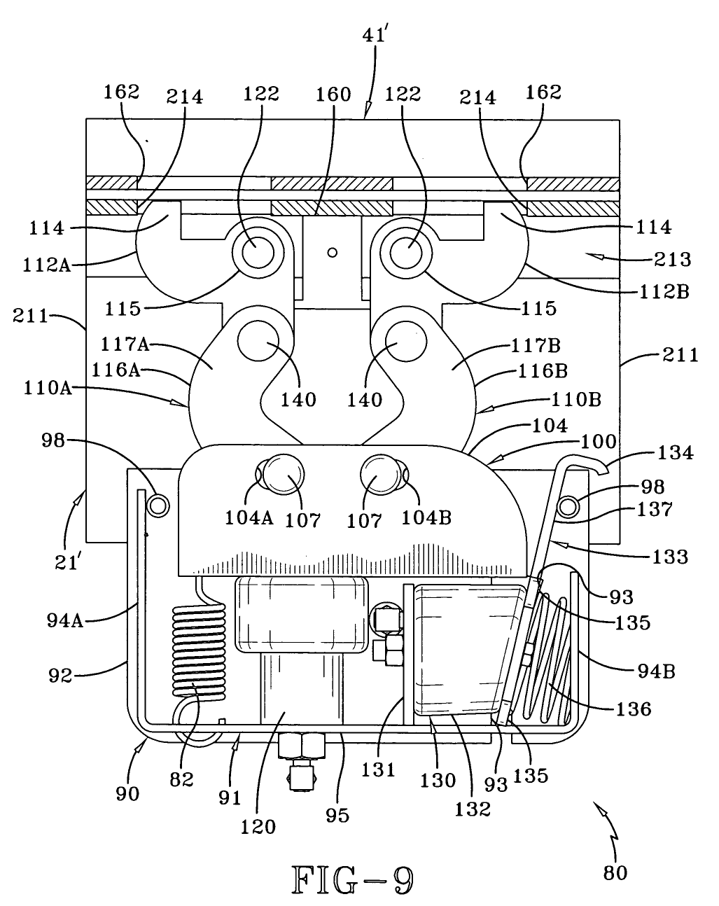

Specifically, clamping arm mechanism 80 (FIGS. 7A and 7B) includes a housing 90, a coil spring 82, an arm base 100, a pair of front and rear clamping arms 110A,B, respectively, an air spring 120, a locking mechanism 130, and an up-stop 160 (FIG. 9). Unless otherwise indicated, all components of clamping arm mechanism 80 are made of a metal such as steel, aluminum, or other suitable material.

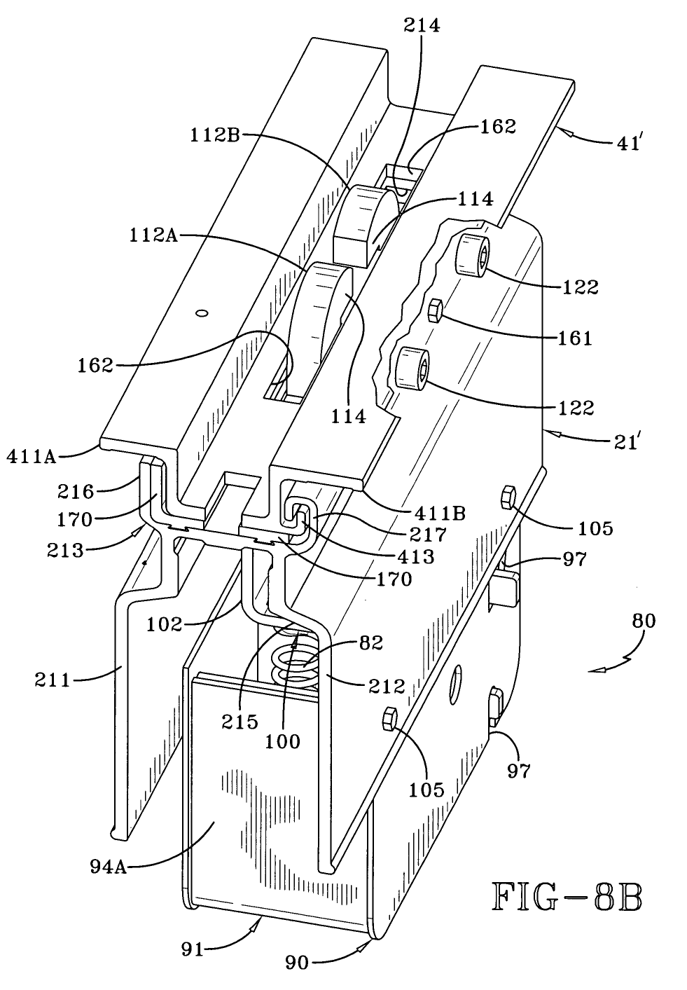

Housing 90 further includes a generally longitudinally extending elongated U-shaped base 91, an inboard plate 92 and an outboard plate 96, which combine to form a generally rectangular-shaped box-like structure having a top opening 99. Inboard plate 92 and outboard plate 96 are vertically disposed in spaced-apart parallel relationship, abut the inboard and outboard edges, respectively, of U-shaped base 91, and are removably connected to each other and to slider box main member 21 by pins or bolts 105 (FIG. 8B) that pass through outer metal sleeves 98, as described more fully below. U-shaped base 91 includes a first vertically-disposed wall 94A, a second vertical wall 94B and a horizontal bottom wall 95, and is positioned between abutting inboard and outboard plates 92,96, respectively, as illustrated in FIG. 7A, to complete the structure of housing 90. U-shaped base 91 further includes an opening 91A for the receipt of a lower end of air spring 120 and an aperture 91B for receipt of a lower end of coil spring 82 (FIG. 7B). More specifically, coil spring 82 is vertically disposed and is captured between the bottom wall 95 of U-shaped base 91 and the lowermost portion of arm base 100, and is in biased tension in a generally vertical direction so as to assist in the lowering of arm base 100 relative to bottom wall 95, as will be described in greater detail hereinbelow. Inboard plate 92 is formed with a plurality of openings 93 for receipt of tabs 135, as described more fully below and illustrated in FIG. 9. Similarly, outboard plate 96 is formed with a plurality of openings 97 for receipt of tabs 135 (FIG. 7A), also as described more fully below. Housing 90 serves to shield coil spring 82, air spring 120, locking mechanism 130 and, when clamping arm mechanism 80 is in the unlocked position, arm base 100, from debris and the elements, such as rain and snow, and also serves as a mounting structure for the coil spring, air spring, locking mechanism and clamping arm mechanism.

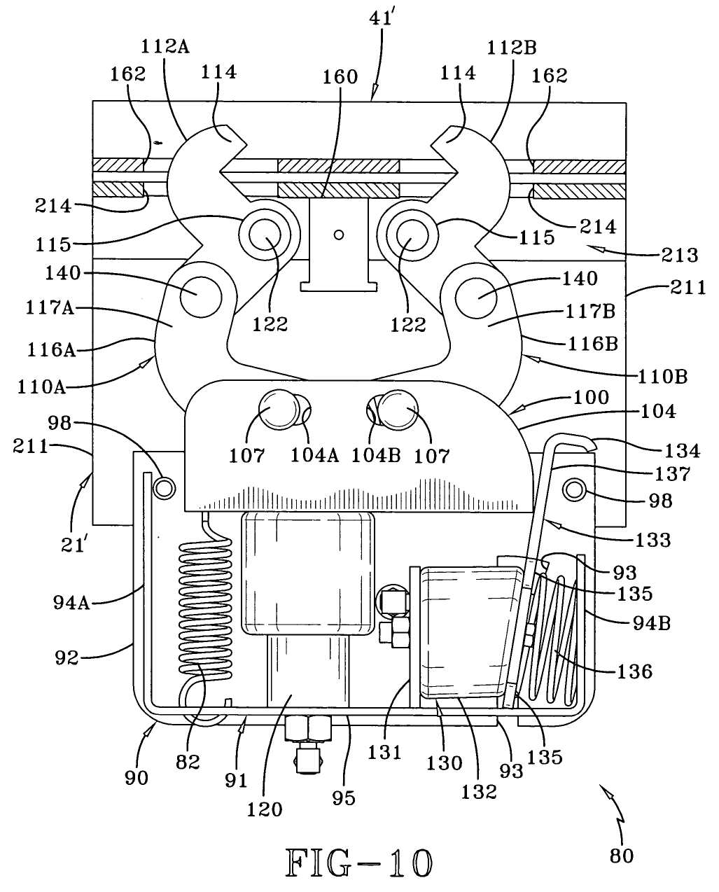

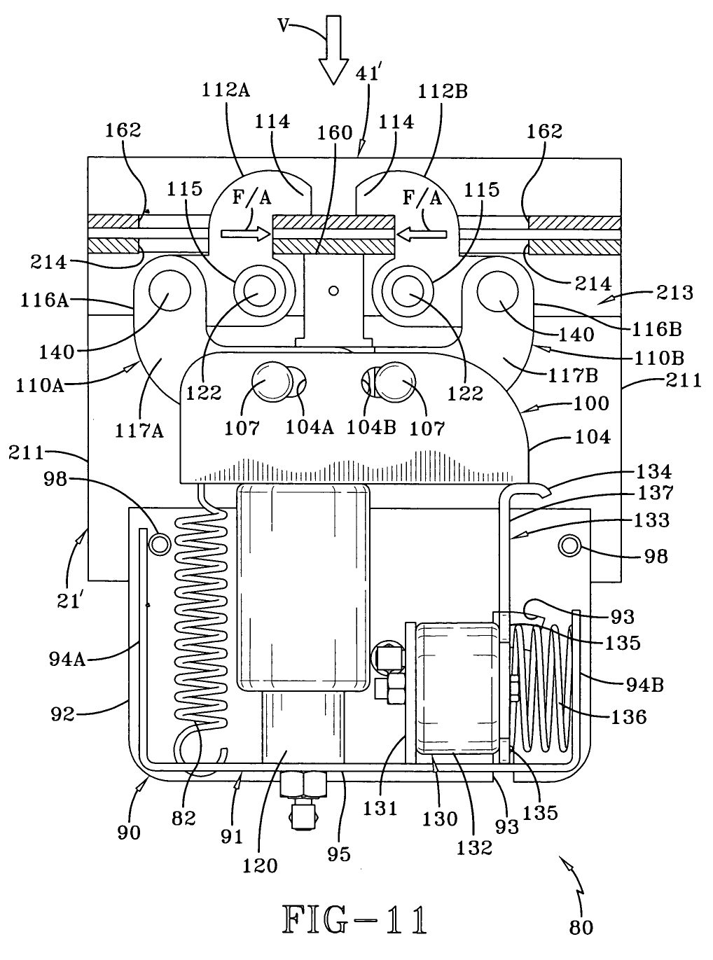

As best shown in FIG. 7B, locking mechanism 130 includes a dividing plate 131, an actuator 132, a locking plate 133 and a coil spring 136. More particularly, dividing plate 131 is a flat plate and is generally perpendicular to, abuts and extends vertically upwardly from bottom wall 95 of U-shaped base 91, to which it is fixedly attached by any suitable means such as welds, between air spring 120 and actuator 132. Actuator 132 is positioned horizontally between and is fixedly attached at its respective ends to dividing plate 131 and locking plate 133 by any suitable means. Actuator 132 preferably is an air spring, but could be any device or mechanism capable of moving locking plate 133 in the direction of and against the bias of coil spring 136 until the coil spring is compressed and the locking plate is disengaged from the lowermost portion of arm base 100 (see FIG. 10). Locking plate 133 is an inverted generally L-shaped plate having a top horizontal flange 134 and a lower vertical portion 137. The plurality of tabs 135 protrude outwardly from locking plate lower portion 137 in both the inboard and outboard directions and perpendicular to inboard and outboard housing plates 92,96, respectively. When housing 90 is fully assembled, tabs 135 extend through inboard housing plate openings 93 and outboard housing plate openings 97. When in the locked position, as shown in FIG. 11, locking plate 133 is generally perpendicular to, and extends vertically upwardly from, bottom wall 95 of U-shaped base 91. Coil spring 136 is captured between and fixedly attached to locking plate lower portion 137 and second wall 94B of U-shaped base 91, and is in biased compression against the locking plate lower portion. The operation of locking mechanism 130 also will be described in greater detail hereinbelow.

Arm base 100 (FIGS. 7A and 7B) is also a generally U-shaped structure having a generally horizontal bottom wall 101, an inboard generally vertical side wall 102 and an outboard generally vertical side wall 104, and can be formed, extruded, or fabricated without affecting the overall concept of the invention. Arm base bottom wall 101 is fixedly attached to the upper portion of air spring 120 by any suitable means, and further includes a spring aperture 106 for receipt of the upper portion of coil spring 82. As more fully described below, as airspring 120 is inflated it overcomes the tension in coil spring 82 and elevates arm base 100 in the direction of trailer body rails 41′.

Inboard side wall 102 and outboard side wall 104 each is formed with a pair of longitudinally spaced-apart openings, with the inboard openings not shown and the outboard openings indicated at 104A,B, for receipt of a base pin 107 therein. The inboard openings and outboard openings 104A,B each generally is a longitudinally elongated opening to permit its respective base pin 107 to move longitudinally therein during the operation of clamping arm mechanism 80, as described more fully below. Arm base 100 preferably is extruded, but also can be formed or fabricated without affecting the overall concept of the invention.

Each one of front and rear clamping arms 110A,B, respectively, further includes an upper arm 112A,B and a lower arm 116A,B as best shown in FIGS. 7A and 7B. More particularly, front lower arm 116A includes a pair of generally L-shaped front plates 117A which are disposed in transversely-spaced parallel relationship to one another and are pivotally attached to arm base 100 by base pin 107. Similarly, rear lower arm 116B includes a pair of generally L-shaped rear plates 117B which are also disposed in transversely-spaced parallel relationship to one another and are also pivotally attached to arm base 100 by base pin 107. Each of front L-shaped plates 117A include a generally rounded rearward extension 119. A spacer 118 formed with a front opening 300 and a rear opening (not shown), is disposed between the front and rear pairs of spaced-apart L-shaped plates 117A,B, respectively, which in turn are disposed between the inboard and outboard side walls 102,104, respectively, of arm base 100. More specifically, the rearward end of spacer 118 is disposed between and fixedly attached to rear L-shaped plates 117B. The forward end of spacer 118 is disposed between and pivotally attached to the rearward extensions 119 of front L-shaped plates 117A by a pin (not shown), or other suitable means of pivotal attachment. The pivotal connection of the forward end of spacer 118 to front L-shaped plates 117A in conjunction with the fixed connection of the rearward end of the spacer to rear L-shaped plates 117B forces front and rear clamping arms 110A,B, respectively, to clamp in unison with one another. Front L-shaped plates 117A each is formed with an opening (not shown) which is aligned with a selected pair of the aligned inboard openings (not shown) and outboard openings 104A formed in side walls 102,104, respectively, of arm base 100 for the receipt of base pin 107 in the aligned openings. Rear L-shaped plates 117B each is formed with an opening (not shown) which is aligned with a selected pair of the aligned inboard openings (not shown) and outboard openings 104B formed in side walls 102,104, respectively, of arm base 100, and the rear opening of spacer 118 (not shown) for the receipt of base pin 107 in the aligned openings. More particularly, each one of front and rear lower arms 116A,B, respectively, is pivotally mounted on arm base 100 by insertion of base pin 107 in the inboard direction through outboard side wall opening 104A,B, and the aligned openings formed in the outboardmost L-shaped plate 117A,B, the inboard most L-shaped plate 117A,B, and the inboard side wall opening (not shown). Alternatively, base pin 107 can be inserted through the same components in the outboard direction without affecting the overall concept of the invention. Once base pin 107 is in place it can be secured by any suitable means such as a nut (not shown).

Each one of front and rear upper arms 112A,B in turn is pivotally connected to a respective one of lower arms 116A,B by arm pin 140, as best illustrated in FIGS. 7A and B. Each one of upper arms 112 is a generally S-shaped plate formed with an opening (not shown) for receipt of arm pin 140. Each one of upper arms 112 further includes a mounting tube 115 that is perpendicular to, and extends outwardly from, the upper arm in both the inboard and outboard directions. Mounting tube 115 preferably is cylindrical in shape and is hollow for receipt of a fastener 122 for rotatably mounting clamping arm mechanism 80 to slider box main members 21′, as best shown in FIGS. 8A and 8B, and described more fully below.

Having described the structure of clamping arm mechanism 80, the preferred location of clamping arm mechanism 80 on slider box 20 will now be described. To accommodate and mount clamping arm mechanism 80 of the present invention, main members 21 and Z-shaped rails 41 of prior art slider box 20 must also be modified as described below. Inasmuch as each one of the pair of clamping arm mechanisms 80 mounted on respective ones of slider box main members 21′ of the present invention is generally identical in structure and operation, only one of the mechanisms and its attachment to its respective main member now will be described. In the preferred embodiment of the present invention, main member 21′ is an inverted generally Y-shaped structure defining a continuous channel 215 (FIG. 8B). More particularly, main member 21′ includes an inboard leg 211, an outboard leg 212 and a top mounting structure 213. Main member 21′ can be formed, fabricated, or extruded without affecting the overall concept of the present invention, and preferably is extruded of a light material such as aluminum. Top mounting structure 213 has a generally U-5 shaped profile with a flat, generally vertical upper portion 216 on the inboard side and an inboardly facing, groove-defining upper portion 217 on the outboard side for engaging trailer body rail 41′ of the present invention, as best illustrated in FIG. 8B. More particularly, rail 41′ of the present invention is extruded and includes a pair of transversely spaced-apart, generally Z-shaped members 411A,B. Z-shaped member 411A is located on the inboard side of rail 41′, and Z-shaped member 411B is located on the outboard side of rail 41′ and further includes an outboardly-extending tongue portion 413 for engaging groove-defining upper portion 217 of main member 21′ as illustrated in FIG. 8B. The tongue and groove relationship of groove-defining upper portion 217 and tongue portion 413 permits movement of main members 21′ and slider tandem 70 in the longitudinal direction relative to trailer body rails 41′, but prevents the slider box from disengaging from the rails, when clamping arm mechanism 80 is in the unlocked position. In the preferred embodiment of the present invention, a low friction strip 170 is attached to portions of the uppermost surface of top mounting structure 213 and the inboard side of upper portion 216 with interlocking dovetails, and extends generally the entire length of the top mounting structure. Strip 170 is formed of any suitable low friction material, such as ultra-high molecular weight polyethylene, and assists in enabling generally smooth movement of slider box 20 along trailer body rails 41′ and, unlike the prior art, generally prevents sticking along the sides of the rails.

Clamping arm mechanism 80 preferably is mounted on main member 21′ adjacent to and forwardly of rear hanger 23B and between inboard leg 211 and outboard leg 212, as best illustrated in FIGS. 8A and 8B, and described more fully below. An up-stop 160 (FIG. 9) also is mounted with a bolt 161 on main member 21′ between upper arms 112 of mechanism 80 and between inboard leg 211 and outboard leg 212 of main member 21′. More particularly, up-stop 160 preferably is formed of aluminum or steel and is mounted on the lowermost surface of and depends from top mounting structure 213, by any suitable means such as welding or with fasteners, and preferably with a bolt 161. Upstop 160 prevents the further upward movement of arm base 100 when clamping arm mechanism 80 is in the locked position (FIG. 11).

As previously described, clamping arm mechanism 80 is mounted on main member 21′, between inboard leg 211 and outboard leg 212, by fasteners 122, each one of which extends through respective aligned openings (not shown) formed in the inboard leg, mounting tube 115 of each one of upper arms 112, and the outboard leg; and by pins 105 which extend through outer metal sleeves 98 of housing 90, inboard leg 211, and outboard leg 212. Fastener 122 preferably is a threaded or shoulder bolt, but could also be a rivet or a pin without affecting the overall concept of the present invention. A second clamping arm mechanism 80 and up-stop 160 are mounted on the opposite main member 21′ at the same location, and in the same manner, so that the two clamping arm mechanisms 80 are in spaced-apart parallel relationship to one another. It also is contemplated that clamping arm mechanisms 80 can be located at other locations along main members 21′ without affecting the overall concept of the present invention.

Having described the structure and location of the present invention, the operation of clamping arm mechanism 80 in the preferred embodiment of the present invention now will be described. As slider box 20 is being selectively slidably positioned beneath trailer body 40, clamping arm mechanism 80 is in the unlocked position as best illustrated by FIG. 9. When clamping arm mechanism 80 is in the unlocked position, air spring 120 is fully deflated and arm base 100 is in its lowermost position due to the biased tension in coil spring 82 which pulls the arm base down toward bottom wall 95 of U-shaped base 91. Additionally, when clamping arm mechanism 80 is in the unlocked position, actuator 132 is fully inflated, which clears locking plate 133 from contact with bottom plate 101 of arm base 100 by overcoming the bias in coil spring 136.

After slider box 20 is positioned in its desired location relative to trailer body 40, the operator will activate the clamping arm mechanism 80 of the present invention by any suitable means such as by flipping a switch (not shown) or turning a key (also not shown). Once clamping arm mechanism 80 is activated, air spring 120 begins to inflate and actuator 132 begins to deflate. As air spring 120 inflates, it overcomes the biased tension in coil spring 82 and elevates arm base 100 in an upward direction toward rail 41′, as best shown in FIG. 10. For the convenience of the reader, and looking at clamping arm mechanism 80 shown in the foreground in FIG. 8A, from the outboard direction in FIGS. 9 through 11, only the movement of the front clamping arm 110A will be described, though it is understood that the rear clamping arm 110B moves in the same manner, only in an opposite pivotal direction. As arm base 100 and front lower arm 116A move upward in the direction of rail 41′, the lower arm rotates in a counterclockwise direction which, by virtue of its connection to front upper arm 112A by arm pin 140, in turn causes front upper arm 112A to pivot about fastener 122 in a clockwise direction as it moves through a selected one of a plurality of openings 214 formed in main member top mounting structure 213, and further through an opening 162 formed in rail 41′, as best illustrated in FIGS. 8B and 10. Of course, it is understood that a plurality of pairs of openings 162 are formed along rail 41′ for receiving upper arms 112, to allow for a large number of possible positions for slider box 20 beneath trailer body 40. Upon full inflation of air spring 120, a hook portion 114 of front upper arm 112A is in mating contact with a top surface of rail 41′ as best shown in FIG. 11. As an important feature of the present invention, clamping arm mechanism 80 is designed so that upper arms 112 come into contact with the top surface of rail 41′ at approximately the same time as up stop 160 comes into contact with lower arms 116A,B as shown in FIG. 11, thereby securely attaching clamping arm mechanism 80 and slider box 20 to rail 41′.

As yet another important feature of the present invention, actuator 132 is deflated simultaneously with the inflation of air spring 120 and elevation of arm base 100. As actuator 132 is deflated, the biased tension of coil spring 136 causes locking plate 133 to move in the direction of dividing plate 131 to the upright position, and the top portion 134 of locking plate 133 mates with the lowermost surface of bottom plate 101 of arm base 100, as shown in FIG. 11. When in the locked position, locking plate 133 prevents the downward movement of arm base 100, thereby further securing the attachment of slider box 20 to rails 41′.

Similarly, when the operator desires to reposition slider box 20, or otherwise disengage clamping arm mechanism 80, the operator disengages clamping arm mechanism 80 by any suitable means such as flipping a switch (not shown) or turning a key (also not shown), which in turn causes actuator 132 to inflate and disengage locking plate 133 from its contact with bottom plate 101 of arm base 100 by pushing locking plate 133 in the direction of and against the bias of coil spring 136. Once locking plate 133 is disengaged from arm base 100, air spring 120 is deflated which in turn permits the biased tension in coil spring 82 to pull arm base 100 downward in the direction of bottom wall 95. As arm base 100 is being lowered, front lower arm 116A pivots in a clockwise direction which, by virtue of its connection to front upper arm 112A by arm pin 140, in turn causes front upper arm 112A to pivot about fastener 122 in a counterclockwise direction as it moves downward through opening 162 in rail 41′ and corresponding aligned opening 214 in main member 21′. It is understood that the same movements are simultaneously occurring on the other clamping arms of mechanism 80 nearest rear hanger 23B, only in the opposite pivotal direction. More specifically, as arm base 100 is lowered, rear lower arm 116B nearest rear hanger 23B pivots in a counterclockwise direction which, by virtue of its connection to rear upper arm 112B by arm pin 140, in turn causes rear upper arm 112B to pivot about fastener 122 in a clockwise direction as it moves downward through rail opening 162 and main member opening 214. Moreover, unlike prior art pins which had to be closely aligned to be engaged, hooks 114 have ample clearance within openings 162 and 214 to allow for slight misalignment, and are much less likely to become jammed.

In accordance with another important feature of the present invention, the operator of the vehicle can easily determine whether clamping arm mechanism 80, and in particular locking mechanism 130, are in the locked position by viewing the location of tabs 135 within openings 97 in outboard plate 96. More specifically, when the operator is viewing clamping arm mechanism 80 in the foreground of FIG. 8A, if tabs 135 are in the leftmost or frontwardmost portion of opening 97, as shown in FIG. 7A, the operator will know that clamping arm mechanism 80 is in the locked position and it is safe to operate the vehicle. If, however, tabs 135 are on the rightmost or rearwardmost side, or any location other than the leftmost portion of opening 97, the operator will know that clamping arm mechanism 80 is in the unlocked position. Similarly, when the operator is viewing passenger-side clamping arm mechanism 80 in the background of FIG. 8A also from the outboard position, if tabs 135 are in the rightmost or frontwardmost portion of opening 97, the operator will know that clamping arm mechanism 80 is in the locked position and it is safe to operate the vehicle. If, however, tabs 135 are on the leftmost or rearwardmost side, or any location other than the rightmost portion of opening 97, the operator will know that clamping arm mechanism 80 is in the unlocked position.

As yet another important feature of the present invention, when clamping arm mechanism 80 is in the locked position, upper arms 112 and hooks 114 are in secure contact with rails 41′ and slider box main members 21′, thereby eliminating the banging of the slider box against floor structure 61 of trailer body 40, and the stresses associated therewith, which is common in the prior art, and thereby permitting the use of lighter materials such as aluminum. More particularly, when in the locked position, hooks 114 of clamping arm mechanism 80 exert a fore-aft clamping force F/A (FIG. 11) on their respective trailer body rail 41′, causing the trailer body rail to be clamped in a secure position to its respective slider box main member 21′ in the fore-aft direction, and thereby reducing, minimizing, or eliminating unwanted movement and gyrations. More specifically, and depending on the orientation of clamping arm mechanism 80 on its respective slider box main member 21′, each one of upper arms 112 and its associated hook 114 exert a force in the fore direction against trailer body rail 41′ and its associated slider box main member, and the other upper arm and its associated hook exerts a force in the aft direction against the trailer body rail and slider box main member. Additionally, when clamping arm mechanism 80 is in the locked position, hooks 114 of the clamping arm mechanism also exert a vertical clamping force V (FIG. 11) on their respective trailer body rail 41′, thereby causing the trailer body rail to be clamped in a secure position to its respective slider box main member 21′ in a vertical direction, and further reducing, minimizing, or eliminating unwanted movement and gyrations. More specifically, each one of upper arms 112 and its associated hook 114 exert a force in the vertical direction against trailer body rail 41′ and its associated slider box main member 21′. It is understood, although both fore-aft and vertical forces are preferred, that the manner in which upper arms 112 and associated hooks 114 engage trailer body rails 41′ and main members 21′ can be adjusted so that only vertical forces or only fore-aft forces are applied without affecting the overall concept.

Therefore, it can be seen that clamping arm mechanism 80 of the present invention overcomes the disadvantages of the prior art retractable pin mechanisms such as mechanism 24, and permits the use of a lightweight, economical slider box that is capable of being easily and securely repositioned relative to the trailer body, and that is relatively easy to manufacture. Clamping arm mechanism 80 also allows for use of aluminum rails 41′, rather than heavier steel, in certain applications, which also contributes to weight savings. Mechanism 80 may also enable use of lighter weight materials on the trailer body itself in certain applications, such as aluminum for cross sills 55 in van-type trailers. The clamping arm mechanism of the present invention has a wide range of potential applications including, without limitation, virtually any application that contemplates the use of a slider box.

The present invention has been described with reference to a specific embodiment. It shall be understood that this illustration is by way of example and not by way of limitation. Other clamping mechanisms that include different structural components and/or clamping means, including those utilizing: hydraulics, pneumatics, or electrical solenoids, are also contemplated by the present invention. Furthermore, the use of a reduced number or an increased number of clamping mechanisms on the slider box, for example, a single clamping arm mechanism or three, four or more clamping arm mechanisms, as well as different locations for placement of the clamping arm mechanism on the slider box, or even on the trailer body, are also contemplated by the present invention. Further potential modifications and alterations will occur to others upon a reading and understanding of this disclosure, and it is understood that the invention includes all such modifications and alterations and equivalents thereof.

Accordingly, the improved locking mechanism for a slider box of a tractor-trailer is simplified, provides an effective, safe, inexpensive, and efficient structure which achieves all the enumerated objectives, provides for eliminating difficulties encountered with prior art retractable pin locking mechanisms, and solves problems and obtains new results in the art.

In the foregoing description, certain terms have been used for brevity, clearness and understanding; but no unnecessary limitations are to be implied therefrom beyond the requirements of the prior art, because such terms are used for descriptive purposes and are intended to be broadly construed.

Moreover, the description and illustration of the invention is by way of example, and the scope of the invention is not limited to the exact details shown or described.

Having now described the features, discoveries and principles of the invention, the manner in which the improved locking mechanism for a slider box is construed, arranged and used, the characteristics of the construction and arrangement, and the advantageous, new and useful results obtained; the new and useful structures, devices, elements, arrangements, parts and combinations are set forth in the appended claims.

What is claimed is:

1. A movable subframe for a tractor-trailer, said tractor-trailer including a longitudinally-extending trailer body, said subframe being movable longitudinally beneath said trailer body, the subframe comprising:
a pair of transversely spaced-apart main members extending longitudinally relative to said trailer body;
at least one cross member extending between and being attached to said main members;
at least one axle/suspension system mounted on and depending from said subframe; and
at least one clamping mechanism, said clamping mechanism being mounted on said subframe for clampingly engaging said trailer body to selectively position the subframe relative to the trailer body.

2. The movable subframe for a tractor-trailer of claim 1, in which said clamping mechanism includes a pair of arms; and in which said arms exert forces on the trailer body and the subframe, wherein said forces are selected from a group consisting of fore-aft forces and vertical forces, to selectively position the subframe relative to the trailer body.

3. The moveable subframe for a tractor-trailer of claim 2, in which each one of said clamping arms moves in a generally vertical direction through a respective one of a pair of openings formed in its respective subframe main member, and through a respective one of a selected aligned pair of openings formed in a trailer body rail.

4. The moveable subframe for a tractor-trailer of claim 1, in which each one of a pair of said clamping mechanisms is attached to a respective one of said subframe main members for clamping each one of the main members to a respective one of a pair of transversely spaced-apart, longitudinally extending trailer body rails.

5. The moveable subframe for a tractor-trailer of claim 4, in which each one of said clamping mechanisms exert clamping loads on its respective subframe main member and respective trailer body rail, wherein said clamping loads are selected from a group consisting of fore-aft clamping loads and vertical clamping loads, to selectively position the subframe relative to the trailer body.

6. The moveable subframe for a tractor-trailer of claim 1, in which said clamping mechanism includes:
a housing attached to a respective one of said main members;
an air spring fluidly connected to an air source, said air spring attached to and disposed within said housing;
an arm base mounted on said air spring for raising and lowering said arm base;
a pair of clamping arms pivotally attached to said arm base;
a first coil spring having a pair of ends, each of said ends attached to a respective one of said arm base and said housing;
a locking mechanism disposed within said housing and generally beneath said arm base, whereby said locking mechanism prohibits said arm base from lowering;
an up-stop attached to said main member generally above said arm base.

7. The moveable subframe for a tractor-trailer of claim 6, including a pair of hangers, each one of said hangers being attached to and depending from a respective one of said main members, for supporting said axle/suspension system.

8. The moveable subframe for a tractor-trailer of claim 7, in which said clamping mechanism is adjacent a respective one of said hangers.

9. The moveable subframe for a tractor-trailer of claim 6, in which said locking mechanism includes:
a dividing plate extending generally vertically upwardly and attached to said housing;
an actuator horizontally disposed and attached to said dividing plate;
a locking plate pivotally attached to said housing, said locking plate being disposed adjacent said actuator and extending generally vertically upwardly from a bottom of said housing, said locking plate contacting said arm base when in a locked position; and
a second coil spring having a pair of ends, each of said ends attached to a respective one of said locking plate and said housing.

10. The moveable subframe for a tractor-trailer of claim 9, in which said clamping arms further comprise:
a lower arm pivotally attached to said arm base; and
an upper arm pivotally attached to said lower arm.

11. The moveable subframe for a tractor-trailer of claim 10, in which said arm base further comprises:
a bottom wall disposed generally horizontally and attached to said air spring;
an inboard side wall extending generally vertically upwardly and attached to said bottom wall, said inboard side wall having a pair of longitudinally-spaced openings;
an outboard side wall extending generally vertically upwardly and attached to said bottom wall, said outboard side wall having a pair of longitudinally-spaced openings; and
a pair of base pins, each of said base pins being disposed generally horizontally through a respective one of said openings in said inboard side wall and said outboard side wall, said base pins pivotally attaching said clamping mechanism to said arm base.

12. The movable subframe for a tractor-trailer of claim 11, including a pair of hangers, each one of said hangers being attached to and depending from a respective one of said main members, for supporting said axle/suspension system.

13. The moveable subframe for a tractor-trailer of claim 12, in which said clamping mechanism is adjacent a respective one of said hangers.
